(19) United States
(12) Patent Application Publication
(10) Pub. No.: US 2009/0300127 A1
(43) Pub. Date: Dec. 3, 2009

(54) E-MAIL FORWARDING METHOD AND SYSTEM

(76) Inventor: Qiang Du, Mountain View, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/477,068

(22) Filed: Jun. 2, 2009

Related U.S. Application Data
(60) Provisional application No. 61/058,324, filed on Jun. 3, 2008.

(51) Int. Cl. G06F 15/16

(52) U.S. Cl. 709/206

(57) ABSTRACT

Systems and methods for allowing a user who has multiple e-mail accounts to read all of the e-mails sent to the multiple accounts from a single account are disclosed. The user may have the ability to reply to the sender of an e-mail such that the original sender is unaware that the user read the e-mail from an account that may be different than the account to which the e-mail was originally sent. The ability to reply to an e-mail in such a manner may not be dependent on the specific e-mail account the user is using to read the e-mail.

### CROSS-REFERENCES TO RELATED APPLICATIONS

This application claims the benefit of and priority to U.S. Provisional Patent Application No. 61/058,324, entitled “E-MAIL FORWARDING METHOD AND SYSTEM,” filed Jun. 3, 2008 (Attorney Docket No. 021300-000500US), the entire contents of which are incorporated herein by reference.

### BACKGROUND

E-mail users today may have multiple e-mail accounts. For example, a user may have several free e-mail accounts at providers such as Yahoo™ or G-mail™. The user may also have an account related to their place of employment. Any number of additional e-mail accounts are also possible. In order to read e-mail messages sent to each of these accounts, a user will typically have to log into each account to retrieve their e-mail messages. This can be time consuming and can cause irritation to the user, as multiple user names and passwords must be remembered. Additionally, each e-mail account provider may have a different user interface, thus adding to the frustration of a user.

One way many internet users have overcome the irritation of multiple e-mail accounts is to designate one of their multiple accounts to be their primary account. The users may then configure the remainder of their e-mail accounts, which may be referred to as secondary accounts, to forward all e-mails received at the secondary accounts to the primary account. In this way, the user is able to read all of their e-mails sent to both the primary account and all the secondary accounts by logging into only the primary account. Most modern e-mail systems provide for the ability to forward all received e-mails to another e-mail account, with the original sender being maintained in the From: field of the e-mail. By maintaining the original sender, the reader of the forwarded e-mail message may simply select the e-mail programs ‘reply’ option, and the reply will be sent to the original sender, as opposed to the account that forwarded the e-mail.

Unfortunately, this leads to a situation in which when a user replies to an e-mail that was forwarded to the primary account, the original sender will receive a reply that appears to have come from the primary account. An example of this may be a user who has both a G-mail™ and Yahoo™ e-mail account. The user's e-mail addresses may be user@gmail.com and user@yahoo.com respectively. The user may designate their G-Mail™ account to be the primary account, and have all e-mail sent to the user@yahoo.com address forwarded to the user@gmail.com account. An original sender sends an e-mail to user@yahoo.com. This e-mail will then be forwarded to the user's G-Mail™ account. The user may then read the e-mail in their G-Mail™ account, and reply to the sender. When the original sender receives the reply, it will appear to have come from user@gmail.com.

It may be undesirable for the original sender to receive a reply that originated from the user's primary e-mail account for any number of reasons. The simplest reason may be that the user does not wish for his primary e-mail account address to be known to senders who would have otherwise only known of the secondary e-mail address. Some e-mail providers have attempted to overcome this situation by providing an option that allows for a different e-mail address to be placed in the From: field of the outgoing reply. For example, G-Mail™ provides a feature referred to as ‘Custom From Field’ which allows a user to reply to an e-mail message, and have the From: field of the reply e-mail contain any e-mail address specified by the user.

A solution such as the one offered by G-Mail™ is unsatisfactory for a number of reasons. First, although the From: address field may contain an e-mail address specified by the user, the actual reply e-mail is still sent by the primary account. A cursory examination of the e-mail headers will reveal that the e-mail address that sent the reply is not the same as the address purported to have sent the reply. Some e-mail client programs, such as Outlook offered by Microsoft™ will explicitly highlight the fact that the reply did not come from where it was purported to have come from. Continuing with the above example, the From: field of the reply might appear to a reader using Outlook as “From: user@gmail.com on behalf of user@yahoo.com.” This solution is unsatisfactory because the goal of maintaining the secrecy of the primary e-mail account is not accomplished.

Secondly, such a solution is not satisfactory because it is dependant on the e-mail provider of the user's primary e-mail account. Should the user decide to change their primary e-mail account to a provider that does not offer a feature similar to G-Mail's™ ‘Custom From Field’ the capability of masking the user's primary e-mail account is lost.

Embodiments of this disclosure address these and other problems individually and collectively.

### BRIEF SUMMARY

Embodiments of the present disclosure provide systems and methods for allowing a user to read an e-mail sent to the user's secondary e-mail account using the user's primary e-mail account. The user may send a reply to the original sender of the e-mail from the primary e-mail account. The reply message received by the sender may appear to the sender as having come from the secondary e-mail account and is indistinguishable from a reply that originated at the secondary e-mail account. The systems and methods may be independent of the provider of the primary e-mail account.

In one embodiment, an e-mail is received at a user's secondary e-mail account on a second e-mail server. The e-mail may have been sent from a sender's e-mail account on a third e-mail server. A link may be appended to the e-mail that includes computer instructions for sending a reply e-mail to the sender. The e-mail may then be forwarded to a user's primary e-mail account on a first e-mail server. The reply e-mail may be sent from the second e-mail server to the sender's e-mail account on the third e-mail server. The reply e-mail may include a from address identifying the secondary e-mail account. The method may be independent of the first and third e-mail servers.

In one aspect, the e-mail sent from the sender may be embedded into an HTML form prior to appending the link to the e-mail. The link may be an HTML mailto: command. The mailto: command may specify a destination address associated with the second e-mail server. The destination address may be the user's secondary e-mail account plus an additional identifier that is recognized by the second e-mail server. A reply e-mail that is initiated by clicking on the mailto: link may be received at the second e-mail server. The destination address may be parsed to recognize the additional identifier. The additional identifier may be extracted to retrieve the user's secondary e-mail account. The sender's e-mail account may be extracted from the reply e-mail. A reply message addressed to the sender's e-mail account may be created. The reply e-mail may be sent to the sender's e-mail account from the user's secondary e-mail account at the second mail server.

In another aspect, activating the appended link may cause the second e-mail server to generate a web page that contains the reply e-mail addressed to the sender's email account. The web page may be sent to a user's computer. The web page may contain a send link. Activating the send link may cause the reply e-mail to be sent from the second e-mail server to the sender's e-mail account.

In another embodiment, a computer readable storage medium storing a plurality of instructions for controlling a processor may be provided. The instructions may cause the processor to perform actions when an e-mail is received at a user's secondary e-mail account on a second e-mail server. The e-mail may have been sent from a sender's e-mail account on a third e-mail server. A link may be appended to the e-mail that includes computer instructions for sending a reply e-mail to the sender. The e-mail may then be forwarded to a user's primary e-mail account on a first e-mail server. The reply e-mail may be sent from the second e-mail server to the sender's e-mail account on the third e-mail server. The reply e-mail may include a from address identifying the secondary e-mail account. The actions may be independent of the first and third e-mail servers.

In yet another embodiment, a system comprising a processor and a memory may be provided. The memory may be coupled to the processor and comprise computer code for receiving an e-mail at a user's secondary e-mail account at a second e-mail server. The e-mail may have been sent from a sender's e-mail account on a third e-mail server. The memory may further include code for appending a link to the e-mail, the link may include computer instructions for sending a reply e-mail to the sender. The memory may further include code for forwarding the e-mail to a user's primary e-mail account at a first e-mail server. The memory may further include code for sending the reply e-mail from the second e-mail server to the sender's e-mail account on the third e-mail server. The reply e-mail may include a from address identifying the secondary e-mail account.

In yet another embodiment, an e-mail is received at a user's secondary e-mail account on a second e-mail server. The e-mail may have been sent from a sender's e-mail account on a third e-mail server. The from address field of the e-mail may be altered to include an identifier recognizable by the second e-mail server. The identifier may indicate that further processing is required for e-mails sent to the altered address. The e-mail with the altered from address may be forwarded to a user's primary e-mail account on a first e-mail server. A reply e-mail may be received at the second e-mail server that is addressed to the altered from address field. The reply e-mail may be processed to retrieve the user's secondary e-mail account and the sender's e-mail account. The reply e-mail may be sent from the user's secondary e-mail account to the sender's e-mail account. The operation of the embodiment may be independent of the first and third e-mail servers.

In one aspect, the altered from address may include appending the user's secondary e-mail account to the from address field of the e-mail received from the sender.

In yet another embodiment, a computer readable storage medium storing a plurality of instructions for controlling a processor may be provided. The instructions may cause the processor to perform actions when an e-mail is received at a user's secondary e-mail account on a second e-mail server. The e-mail may have been sent from a sender's e-mail account on a third e-mail server. The from address field of the e-mail may be altered to include an identifier recognizable by the second e-mail server. The identifier may indicate that further processing is required for e-mails sent to the altered address. The e-mail with the altered from address may be forwarded to a user's primary e-mail account on a first e-mail server. A reply e-mail may be received at the second e-mail server that is addressed to the altered from address field. The reply e-mail may be processed to retrieve the user's secondary e-mail account and the sender's e-mail account. The reply e-mail may be sent from the user's secondary e-mail account to the sender's e-mail account.

In yet another embodiment, a system comprising a processor and a memory may be provided. The memory may be coupled to the processor and comprise computer code for receiving an e-mail at a user's secondary e-mail account at a second e-mail server. The e-mail may have been sent from a sender's e-mail account on a third e-mail server. The memory may further include code for altering a from address field of the e-mail to include an identifier recognizable by the second e-mail server. The identifier may indicate further processing is required for e-mails sent to the altered address. The memory may further include code for forwarding the e-mail with the altered from address field to a user's primary e-mail account at a first e-mail server. The memory may further include code for receiving, at the second e-mail server, a reply e-mail addressed to the altered from address field. The memory may further include code for processing the reply e-mail to retrieve the user's secondary e-mail account and the sender's e-mail account. The memory may further include code for sending the reply e-mail from the user's secondary e-mail account to the sender's e-mail account.

These and other embodiments of the disclosure are described in detail below.

### BRIEF DESCRIPTION OF THE DRAWINGS

FIG. 1 depicts a typical system wherein a user reads e-mail sent to one e-mail account using a second e-mail account.

FIG. 2 shows a system diagram according to one embodiment.

FIG. 3(a-b) shows a flow chart according to the embodiment of FIG. 2.

FIG. 4 shows a system diagram according to another embodiment.

FIG. 5(a-b) shows a flow chart according to the embodiment of FIG. 4.

FIG. 6 shows a system diagram according to another embodiment.

FIG. 7(a-b) shows a flow chart according to the embodiment of FIG. 6.

FIG. 8 is a block diagram illustrating components of an exemplary operating environment in which various embodiments may be implemented.

FIG. 9 illustrates an exemplary computer system, in which various embodiments may be implemented.

### DETAILED DESCRIPTION

In the following description, for the purposes of explanation, specific details are set forth in order to provide a thorough understanding of embodiments of the disclosure. However, it will be apparent that embodiments of the disclosure may be practiced without these specific details.

Embodiments of the present disclosure provide systems and methods for allowing a user who has multiple e-mail accounts to read all of the e-mails sent to the multiple accounts from a single account. The user may have the ability to reply to the sender of an e-mail such that the original sender is unaware that the user read the e-mail from an account that may be different than the account to which the e-mail was originally sent. The ability to reply to an e-mail in such a manner may not be dependent on the specific e-mail account the user is using to read their e-mail.

Electronic mail, more colloquially referred to as e-mail, is generally a method of exchanging digital information for use by human users. For purposes of clarity, the present disclosure will refer to e-mails that are being sent from one user to another user. This is for purposes of clarity and ease of understanding only. Embodiments of the present disclosure are equally applicable in cases where one or more users are not human, but may be computer systems.

The types of digital information that can be exchanged by users in an e-mail is vast. Communications can be as simple as text based messages, similar to those that may be present in a letter typed on paper. E-mails can also contain more complex content, such as pictures, audio files, video files, multimedia files, or any other type of digital information. Embodiments of the present disclosure are applicable to all e-mails, regardless of the specific content carried by the e-mail.

In order to use e-mail, a user will typically require an e-mail account. An e-mail account is generally an account on a computer system, which may be also be referred to as an e-mail server, that provides the user with the ability to send and receive e-mail. Associated with the e-mail account will be an e-mail address that identifies the e-mail account and allows others to send e-mails to the user. The format of an email address is typically a username, followed by the at sign, followed by the computer system that is providing the e-mail account. For example, examiner@uspto.gov may indicate a user who has the user name ‘examiner’ and an e-mail account that is being provided by a computer within the uspto.gov domain. A user's e-mail account is often simply referred to as the user's e-mail address. This convention will be applied throughout this disclosure.

A user is not limited to having a single e-mail account. A user may have several different e-mail accounts provided by several different account providers. The user may even have several different e-mail accounts provided by a single account provider. One typical example of an e-mail account may be an account provided by a user's employer. Such an account may be conditioned on the continued employment of the user by the employer. Another example of a conditioned account is an account that may be provided by an educational institution to its students. The account may only be provided if the student maintains a relationship with the educational institution.

In addition to e-mail accounts provided by employers and educational institutions, e-mail accounts may also be provided by Internet Service Providers that provide dial-up or broadband internet access to a user. As part of the service of providing internet access, the Internet Service Provider may provide at least one e-mail account to the user. Typically, the Internet Service Provider charges a fee to provide internet access and will include several e-mail accounts. In some cases, the user may be able to obtain additional e-mail accounts by paying a larger fee.

In addition to the conditioned e-mail accounts and fee based e-mail accounts as described above, there are several sources of free e-mail accounts. Some of the more popular free e-mail accounts are provided by Yahoo™, Google™, and Microsoft™. Typically, these free e-mail accounts are able to operate by placing advertisements within the interface the user utilizes to access his e-mail account. Advertisers will pay the free e-mail account provider to display their ads to the users, and this is how the free e-mail account providers generate revenue to support the infrastructure required to provide the free e-mail service, and potentially even allow the free e-mail account provider to make a profit on the service.

With the relative ease and low cost of obtaining e-mail accounts, it should be clear that many users may have more than one e-mail account. For example, a user may use his employer provided e-mail account solely to send and receive employment related e-mails. The user may use a free e-mail account to send and receive e-mails that are personal.

In order to retrieve their e-mail messages, a user is typically required to log into their e-mail account. In some cases this may require an application running on a user's computer, such as Microsoft™ Outlook. In other cases, a user may access their e-mail account through a web interface using a web browser. One such browser is Internet Explorer provided by Microsoft™. It should be clear that as the number of e-mail accounts an individual user has increases, the number of different systems the user must access to retrieve their e-mail also increases. As each e-mail account application or web interface may be different, the user is additionally burdened with remembering how to use the multiple different interfaces.

Users who have multiple e-mail accounts may desire to access all of their e-mails from a single e-mail account. In response to this desire, most providers of e-mail accounts have implemented features that allow e-mail that is sent to one e-mail account to be forwarded or retrieved by a second e-mail account. The e-mail account provider may allow the user to specify that all his e-mails should be forwarded to an account specified by the user. In other cases, the provider of the e-mail account may allow another e-mail account to retrieve e-mail messages through a defined protocol, such as POP3 (Post Office Protocol).

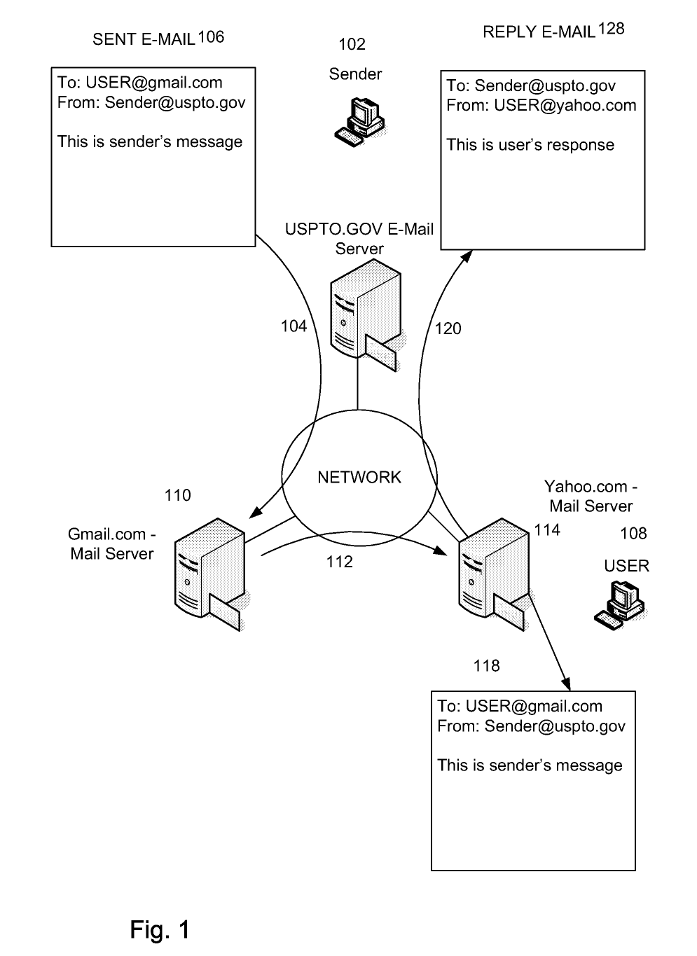

This results in the user being able to read all of his e-mails at a single e-mail account, thus alleviating the need for accessing the e-mail server of each of his individual accounts. However, this does not alleviate a problem that arises when the user wishes to respond to the sender of the e-mail, as will be described with reference to FIG. 1.

FIG. 1 depicts a typical system wherein a user reads e-mail sent to one e-mail account using a second e-mail account. For purposes of clarity, for the remainder of this disclosure, the e-mail account wherein the user desires to read his e-mail will be referred to as the primary e-mail account on the primary e-mail server. Other e-mail accounts owned by the user will be referred to as secondary e-mail accounts on secondary e-mail servers. For purposes of simplicity, only a single secondary e-mail account will be shown, but it should be understood that the user may have any number of secondary e-mail accounts. The designation of an e-mail account or e-mail server as primary or secondary is merely for purpose of identification, and is not intended to imply superiority of one e-mail account over another.

The system depicted in FIG. 1 may contain two users. The first user may be referred to as Sender 102 and may have an e-mail account provided by an e-mail server 104 in the uspto.gov domain. As such, Sender's e-mail address may be Sender@uspto.gov. The system may also include a second user, who will be referred to a USER 108. USER 108 may have two e-mail accounts, one provided by an e-mail server 110 in the gmail.com domain, and having an e-mail address of USER@gmail.com. The second e-mail account may be provided by an e-mail server 114 in the yahoo.com domain, and having an e-mail address of USER@yahoo.com.

USER 108 may decide he wishes to read all of his e-mails in his account that is provided by the e-mail server 114 in the yahoo.com domain. As such, the USER@yahoo.com e-mail address may be considered his primary e-mail account. The user may then configure his e-mail account at the gmail.com e-mail server 110 to forward all messages received addressed to USER@gmail.com to USER@yahoo.com. In an alternate implementation, rather than forwarding the e-mail, the user may configure his e-mail account at the yahoo.com e-mail server 114 to retrieve e-mails addressed to USER@gmail.com from the gmail.com e-mail server 110. In either case, the e-mail account identified by USER@gmail.com on the gmail.com e-mail server 110 may be referred to as the secondary e-mail account.

Sender 102 may desire to send an e-mail to USER@gmail.com. Sender 102 will access his e-mail account on the uspto.gov e-mail server 104, and select an option to create a new e-mail message 106. The sender may enter the desired destination address, which in this case may be USER@gmail.com. Although e-mail message 106 is depicted as showing Sender's e-mail account Sender@uspto.gov in the From: field, this information is not entered by Sender 102. This information is typically entered by the e-mail server that is sending the e-mail message. Sender 102 may finish composing his e-mail message 106 and indicate to the uspto.gov e-mail server 104 that he wishes for the message 106 to be sent. In some cases, this may comprise clicking a button to send the e-mail.

The e-mail 106 may then be processed by e-mail server 104. E-mail server 104 may examine the To: field to determine the destination e-mail server. This may typically be accomplished with a query to a domain name server (DNS) (not shown) to determine the address of the e-mail server associated with the specified domain. In this example, the To: field indicates that e-mail 106 is destined for the gmail.com domain. The DNS query may return the address of the gmail.com e-mail server 110. E-mail server 104 may then send the e-mail to e-mail server 110.

Upon receipt of e-mail 106 by the gmail.com e-mail server, the server may retrieve the account settings of the user specified in the To: line of e-mail 106. In this case, the account settings of the USER@gmail.com e-mail account may indicate that the e-mail 106 should be forwarded to USER@yahoo.com which is associated with the yahoo.com e-mail server 112. Typically, prior to forwarding the message, the gmail.com e-mail server 110 may modify the To: and From: field of the e-mail prior to forwarding. This is so replies to the e-mail message will be sent to the original sender, as opposed to the e-mail account that is forwarding the e-mail.

The USER 108 may access his e-mail account at the yahoo.com e-mail server 114 through an application on his computer, a web interface, or any other suitable means. Once USER 108 has gained access to his account, he may see that he has a new e-mail 118, and may choose to read it. It should be noted that e-mail 118 has had the To: field modified to indicate that the original message was sent to USER@gmail.com. This may inform the USER 108 that this e-mail was originally sent to his USER@gmail.com e-mail account.

USER 108 may choose to reply to the e-mail 118. All programs or interfaces for accessing an e-mail account will provide some feature for replying to an e-mail. Typically this may be in the form of a ‘reply’ button. Upon clicking the ‘reply’ button, the USER 108 may be able to enter whatever information he desires to convey to the original sender. For example, a response to a question that was asked by Sender 102. E-Mail server 114 may examine the From: address in e-mail 118 to prepare a response e-mail. The address contained in the From: field may then be placed in the To: field of the response e-mail. As explained above, the From: field in the response e-mail will be filled in by the sending e-mail server. The yahoo.com e-mail server may then proceed to send 120 the response to the e-mail account identified by Sender@uspto.gov through the same mechanism as described above.

Sender 102 may then read the response e-mail 128. However, a problem has been introduced in that the response e-mail 128 indicates the response came from USER@yahoo.com. This is not the address that Sender 102 sent the original e-mail to. As such, Sender 102 is now aware of the actual e-mail address that USER 108 is using to read his e-mail. This can be a problem for USER 108 for any number of reasons, but the most straightforward one is that USER 108 does not wish for Sender 102 to know about the USER@yahoo.com e-mail account.

What is needed is a solution that allows a user who receives e-mail that was originally sent to a secondary account, but is being read at a primary account, to respond to the e-mail such that when the original sender receives the reply, it will appear to have originated from the secondary account. The solution should not be dependent on which account is designated as the primary account, as the user may decide to change which account is primary, but rather should be based on the forwarding secondary e-mail account systems. Such a solution will advantageously allow a user to change the e-mail account he desires to be primary at will, without losing the ability to reply to messages while still maintaining the privacy of his primary e-mail account.

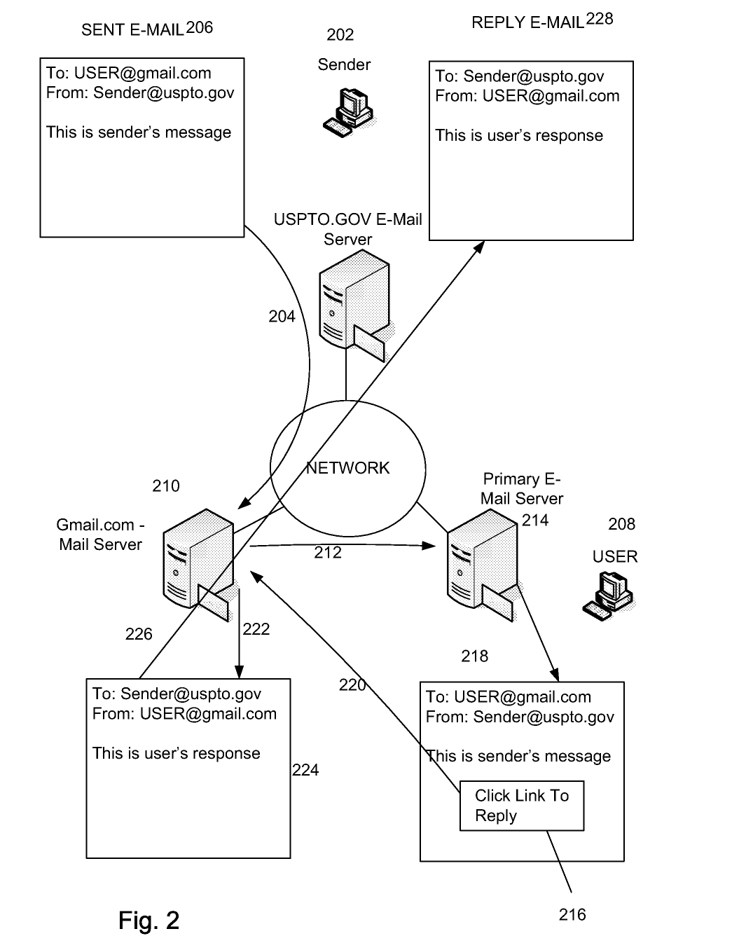

FIG. 2 shows a system diagram according to one embodiment of the disclosure. In one embodiment, a sender 202 may send 204 an e-mail 206 to a user's 208 secondary e-mail account 210. The secondary e-mail account 210 may be configured to forward 212 the e-mail to the user's primary account 214. In an alternate embodiment, the user's 208 primary e-mail account may be configured to retrieve the e-mail from the user's 208 secondary e-mail account.

Prior to forwarding the e-mail, the secondary e-mail account 210 can also be configured to insert a link 216, such as an HTML (Hyper Text Markup Language) link, into the forwarded message 218 that allows the user 208 to reply to the e-mail, such that the reply appears to the sender as having come from the secondary e-mail account. The link may be an HTML ‘href’ link. If the user clicks on this link 220, a reply window 222 will be generated by the secondary e-mail account 210 and displayed 224 on the user's 208 screen. The reply window may optionally require the user to enter a username and password corresponding to the user's account at the secondary e-mail server. In an alternate embodiment, the username and password may be included within the link, such that the information is sent to the secondary e-mail account as part of clicking the link.

The user may then type their response message and execute the send function, as supplied by the secondary e-mail account server 226. The secondary e-mail server will modify the fields in the e-mail header to indicate the e-mail was sent from the secondary e-mail account. The e-mail will then be sent to the original sender by the secondary e-mail server, and will appear as if it came from the secondary e-mail account 228 because it was actually sent from the secondary e-mail server 210.

This process may be further understood by use of an example. An original sender (e.g. Sender@uspto.gov) may send an e-mail message to USER@gmail.com, which is the user's secondary e-mail account. The secondary e-mail account sever may add an HTML link into the e-mail message, and forward it to the user's primary e-mail account. The user may then read the e-mail at their primary e-mail account. The user can then click the link, and this may cause a reply window to be generated by the secondary e-mail server and displayed on a web browser on the user's computer. The use of an HTML link to open a window is well known.

The e-mail addresses to be used as the sender and recipient can be included in the link (for example, through the use of the HTTP POST method). The user can then enter their response, and execute the send function provided by the generated window. The secondary e-mail server will then insert the response into an e-mail addressed to the original sender and sent from the user's secondary e-mail account. The response will appear as if it came from the secondary e-mail account, because it did in fact come from the user's secondary account. When the original sender receives the e-mail, it will indicate that it came from USER@gmail.com, despite the fact that the user read the e-mail, and replied to it, from within their primary e-mail account.

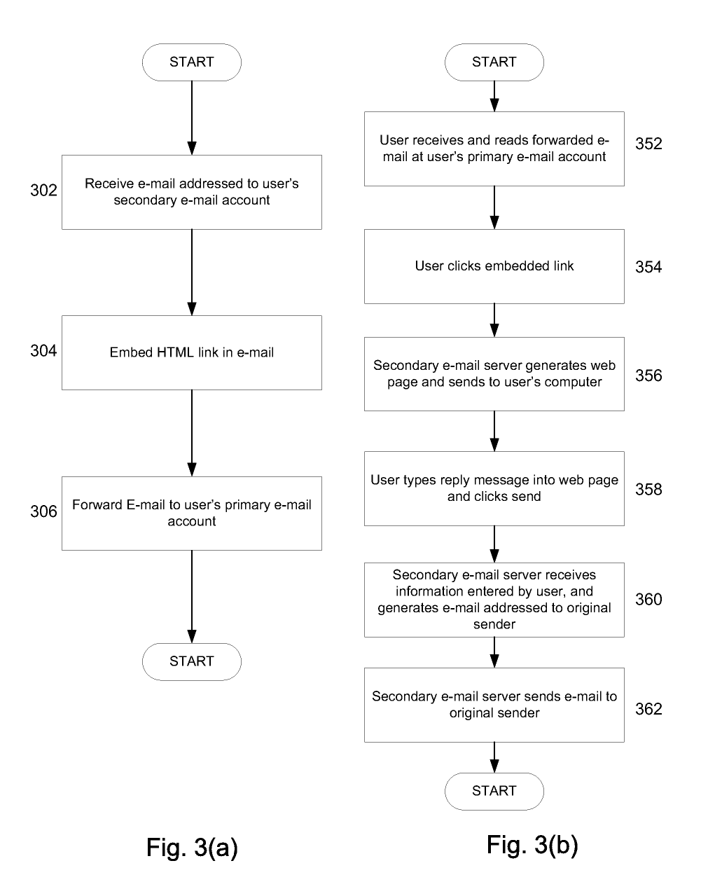

FIG. 3(a-b) shows a flow chart according to the embodiment of FIG. 2. FIG. 3(a) depicts the processing done by the secondary e-mail server upon receipt of a new message. The process begins at step 302 where an e-mail addressed to a user's e-mail account is received. The secondary e-mail server may then embed an HTML link, as discussed above, into the e-mail at step 304. The e-mail is then forwarded to the user's primary e-mail account at step 306.

FIG. 3(b) depicts the processing that is done in order for a user to reply to an e-mail sent to a secondary account from a primary account, and have the response appear to have come from the secondary account. The process begins at step 352 wherein the user receives and reads the e-mail forwarded at step 306 using his primary e-mail account. At step 354, the user may click on the link that was embedded into the e-mail at step 304. At step 356, the secondary e-mail server generates a web page that will allow the user to enter his response to the e-mail. This web page is sent to the user's computer.

At step 358, the user types his reply message into the web page that was sent at step 356, and clicks a send button provided by the web page. The information entered into the web page may be received by the secondary e-mail server at step 360. The secondary e-mail server may then generate an e-mail addressed to the original sender of the e-mail, and insert the content provided by the user at step 358. The secondary e-mail server may then send the e-mail to the original sender at step 362. Because the e-mail is actually sent from the secondary e-mail server, it will appear to the original sender as having come from the secondary e-mail account.

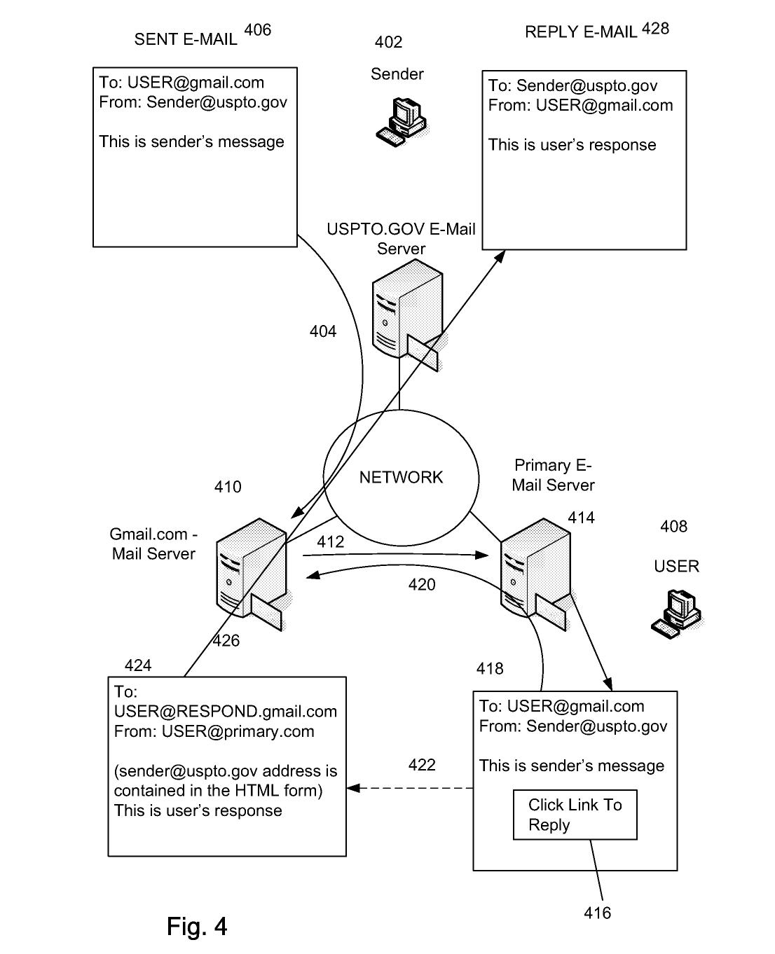

FIG. 4 shows a system diagram according to another embodiment of the disclosure. In this embodiment, a sender 402 may send 404 an e-mail 406 to a user's 408 secondary e-mail account 410. The secondary e-mail account 410 may be configured to forward 412 the e-mail to the user's primary account 414. The secondary e-mail server 410 can be configured to forward the e-mail to the user's primary account 414 as content within an HTML form 418.

Within the form can be a link 416 allowing the user to reply as if the message originated from the secondary e-mail account 410. The link may be an HTML ‘mailto:’ link. Clicking the link 422 will cause the user's default e-mail program to open a reply window, with the reply To: address set as whatever was set in the ‘mailto:’ link on the HTML form. The ‘mailto:’ link may be set by the secondary e-mail server to specify the mail be sent to the user's account at the secondary mail server, with an additional indication that the message should be modified and resent. The user may then type their response and execute the send function provided by the default e-mail program 420.

The e-mail will then be sent by whichever e-mail server is defined as the default. Upon receipt at the secondary e-mail server 410, the secondary e-mail server can read the indication 424 that the message should be modified and resent 426. The e-mail address of the original sender can be retrieved from the body of the e-mail. The secondary e-mail server may create a new e-mail addressed to the original sender, and copy the contents of the received e-mail into the new e-mail. The secondary e-mail server may send the e-mail from the user's e-mail account on the secondary server to the original sender 428.

This process may be further understood by use of an example. An original sender (e.g. Sender@uspto.gov) may send an e-mail message to USER@gmail.com, which is the user's secondary e-mail account. The secondary e-mail server may then take the e-mail message and put the content into an HTML form, where the form contains a ‘mailto:’ link, with the address set to USER@RESEND.gmail.com. The secondary e-mail server may then place the HTML form within an e-mail, and send the e-mail to the primary e-mail account.

The user may then read the e-mail in his primary e-mail account and click the ‘mailto:’ link. The default e-mail program can create a response window, with the address set to USER@RESEND.gmail.com. The user may type their response, and execute the send function. The e-mail will be sent by the default mail program through the default mail server to the USER@RESEND.gmail.com account, which is located on the secondary e-mail server.

The secondary e-mail server can detect RESEND in the address line, and create a new e-mail addressed to the original sender, Sender@uspto.gov. The original sender's e-mail address may be extracted from the body of the received e-mail. The secondary e-mail server can place the contents of the received message into the new e-mail and send the e-mail to the original sender. The use of RESEND as an indicator is only exemplary, and any other suitable indicator may also be used. As such, this particular example should not be considered limiting. The use of a default e-mail program configured to respond to the ‘mailto:’ HTML tag is well known.

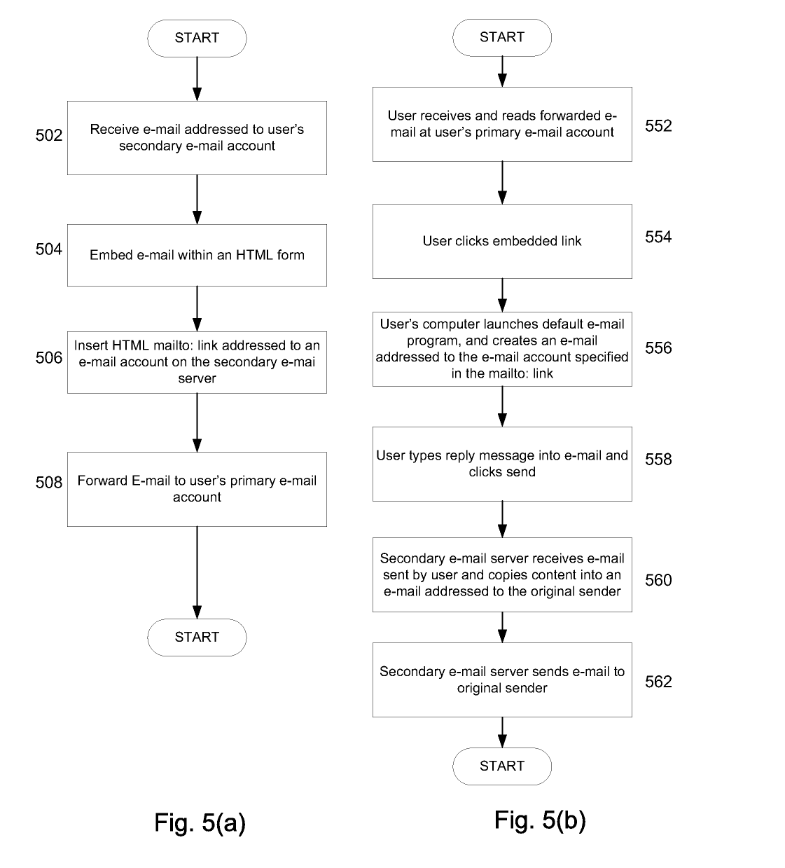

FIG. 5(a-b) shows a flow chart according to the embodiment of FIG. 4. FIG. 5(a) depicts the processing done by the secondary e-mail server upon receipt of a new message. The process begins at step 502 where an e-mail addressed to a user's e-mail account is received. The secondary e-mail server may then embed the e-mail within an HTML form at step 504. At step 506, the secondary e-mail server may insert a HTML ‘mailto:’ link addressed to an e-mail account on the secondary server. In accordance with the example of FIG. 4, this e-mail address may be the user's e-mail address on the secondary e-mail server with the indicator RESEND appended. The secondary e-mail server may then forward the e-mail to the primary e-mail account at step 508.

FIG. 5(b) depicts the processing that is done in order for a user to reply to an e-mail sent to a secondary account from a primary account, and have the response appear to have come from the secondary account. The process begins at step 552 wherein the user receives and reads the e-mail forwarded at step 508 using his primary e-mail account. At step 554, the user may click on the link inserted in step 506. At step 556 the user's computer may launch the default e-mail program associated with an HTML ‘mailto:’ link and create an e-mail addressed to the address specified in step 506. At step 558, the user types his response message and clicks send.

At step 560, the e-mail sent at step 558 is received by the secondary e-mail server. The secondary e-mail server may then copy the contents of the e-mail into a new e-mail addressed to the original sender. The original sender's e-mail address may be retrieved from the body of the received e-mail. For example, in accordance with the description above, the original sender's e-mail address Sender@uspto.gov could be retrieved from the body of the HTML form. At step 562 the secondary e-mail server can send the newly created e-mail to the original sender from the user's e-mail account at the secondary e-mail server. Because the e-mail is actually sent from the secondary e-mail server, it will appear to the original sender as having come from the secondary e-mail account.

In yet another embodiment, a sender 602 may send 604 an e-mail 606 to a user's 608 secondary e-mail account 610. The secondary e-mail account 610 may be configured to forward 612 the e-mail to the user's primary account 614. The secondary e-mail server can be configured to forward the e-mail to the user's primary account, but rather than forwarding the original e-mail header information, the header information can be modified 616 to indicate that replies to the e-mail should receive additional processing.

The user may then read the e-mail at the primary account 618. The user may reply 620 to the e-mail at the primary account through the normal procedures provided by the primary account. The modified headers will cause the reply 622 to be sent to the secondary e-mail server 610. The secondary e-mail server may then modify the e-mail message to appear as if it was sent from the secondary e-mail account and then send 624 the message to the original sender 628.

This process may be further understood by use of an example. An original sender (e.g. Sender@uspto.gov) may send an e-mail message to USER@gmail.com, which is the user's secondary e-mail account. The secondary e-mail server can modify the e-mail header for later processing. As one example, the secondary e-mail server may modify the sender to be ‘user+sender+at+uspto.gov@gmail.com.’ In this example, the +signs will be used later, so the secondary e-mail server can determine the actual e-mail addresses involved. The use of the + sign is only one example of an indicator that may be used, and is not limiting as any other suitable indicator may also be used. In an alternative embodiment, the original senders e-mail address may be stored in a database, and an identifier related to the database entry comprise the modified e-mail header. This e-mail message can then be forwarded to the user's primary e-mail account.

When the user reads the e-mail at the primary e-mail account, the sender will be ‘user+sender+at+uspto.gov@gmail.com.’ The user then may reply to this e-mail, and the response will be sent by the primary e-mail account to the address ‘user+sender+at+uspto.gov@gmail.com’, which is on the secondary e-mail account server. When the response is received, the secondary e-mail server can detect the addition to the e-mail address by parsing the destination address to determine that the + identifier is present. The message header can be parsed such that the original sender Sender@uspto.gov is removed, and placed in the To: line of an e-mail. The From: line of the e-mail can be populated with the user's e-mail address at the secondary e-mail server, USER@gmail.com.

The e-mail can then be sent to the original sender. When the original sender receives the e-mail, it will indicate that it came from USER@gmail.com, despite the fact that the user read the e-mail, and replied to it, from within their primary e-mail account.

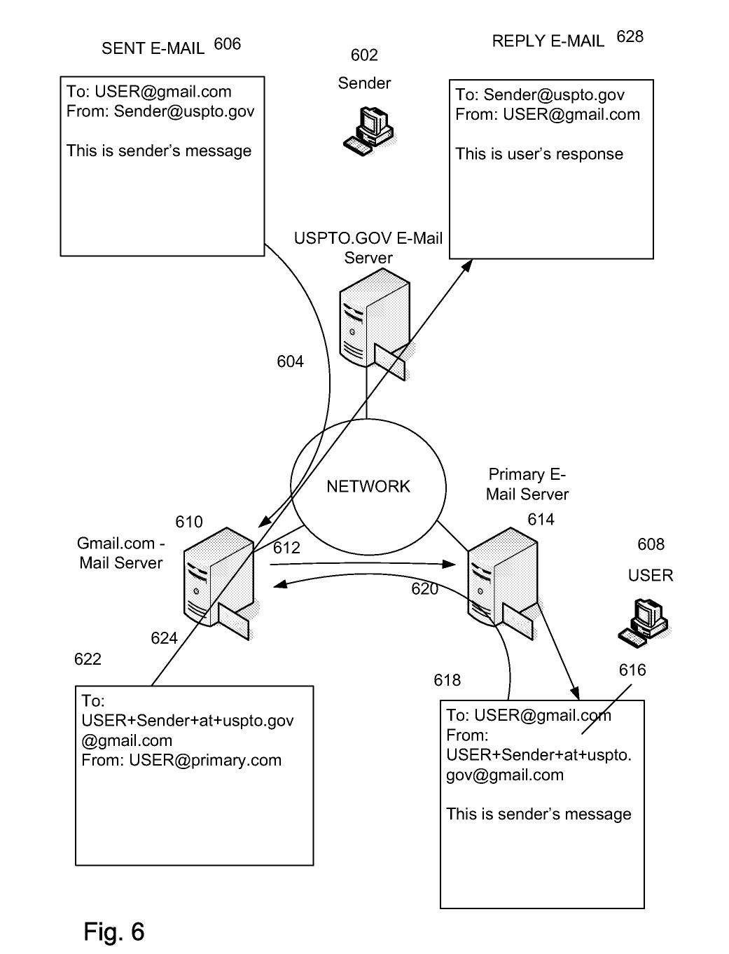

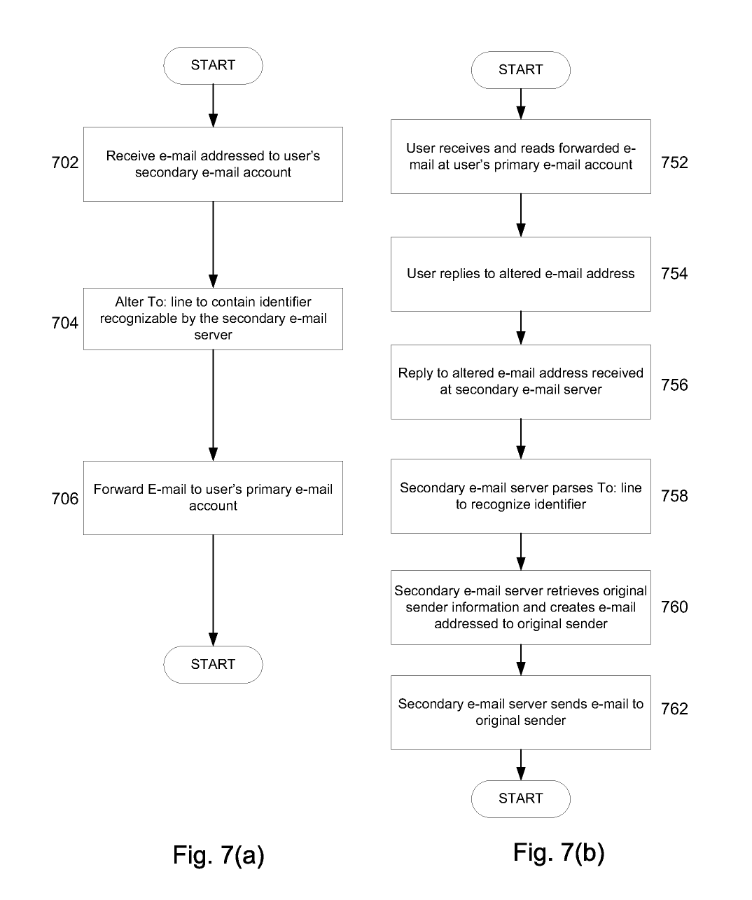

FIG. 7 shows a flow chart according to the embodiment of FIG. 6. FIG. 6(a) depicts the processing done by the secondary e-mail server upon receipt of a new message. The process begins at step 702 where an e-mail addressed to a user's e-mail account is received. The To: line of the e-mail may be altered at step 704 to contain an identifier that is recognizable by the secondary e-mail to identify the original sender and receiver of the e-mail. At step 706, the e-mail can be forwarded to the user's primary e-mail account.

FIG. 7(b) depicts the processing that is done in order for a user to reply to an e-mail sent to a secondary account from a primary account, and have the response appear to have come from the secondary account. The process begins at step 752 wherein the user receives and reads the e-mail forwarded at step 706 using his primary e-mail account. At step 754 the user may reply to the e-mail, which will be a reply to the e-mail address as it was altered in step 704.

The reply e-mail sent in step 754 may be received by the secondary e-mail server in step 756. At step 758 the secondary e-mail server may parse the To: line in the e-mail to recognize the identifier that was inserted in step 704. The secondary e-mail server may then retrieve the original sender's e-mail address and create an e-mail addressed to the original sender at step 760. At step 762, the secondary e-mail server can send the e-mail to the original sender from the user's secondary e-mail account. Because the e-mail is actually sent from the secondary e-mail server, it will appear to the original sender as having come from the secondary e-mail account.

Embodiments of the present disclosure have been described above with reference to specific examples. These specific embodiments are merely exemplary, and are not intended to be limiting.

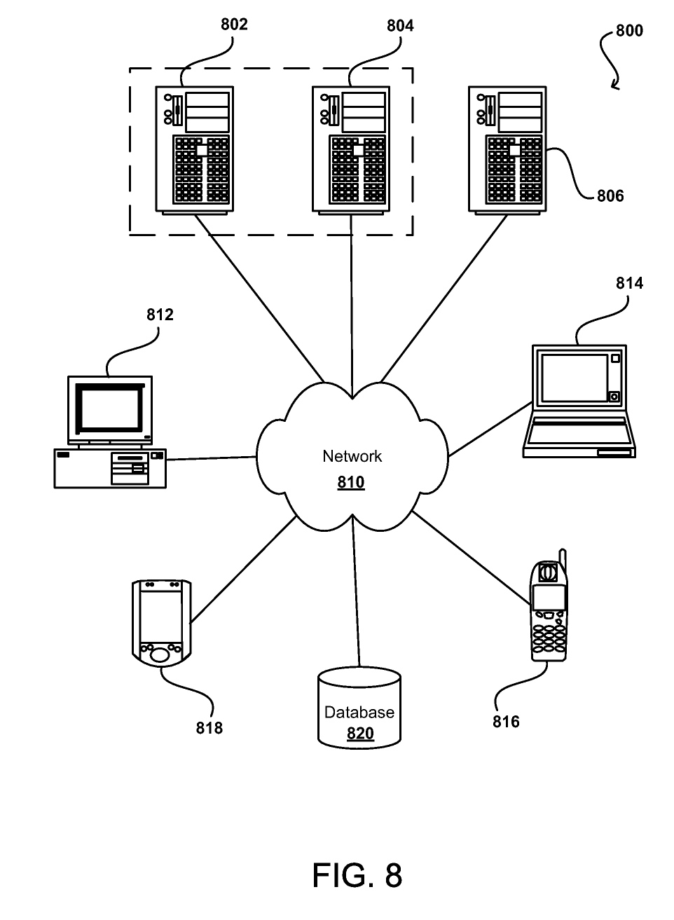

FIG. 8 is a block diagram illustrating components of an exemplary operating environment in which various embodiments may be implemented. The system 800 can include one or more user computers, computing devices, or processing devices 812, 814, 816, 818, which can be used to operate a client, such as a dedicated application, web browser, etc. The user computers 812, 814, 816, 818 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 812, 814, 816, 818 may also have any of a variety of applications, including one or more development systems, database client and/or server applications, and Web browser applications. Alternatively, the user computers 812, 814, 816, 818 may be any other electronic device, such as a thin-client computer, Internet-enabled gaming system, and/or personal messaging device, capable of communicating via a network (e.g., the network 810 described below) and/or displaying and navigating Web pages or other types of electronic documents. Although the exemplary system 800 is shown with four user computers, any number of user computers may be supported.

In most embodiments, the system 800 includes some type of network 810. The network may can be any type of network familiar to those skilled in the art that can support data communications using any of a variety of commercially-available protocols, including without limitation TCP/IP, SNA, IPX, AppleTalk, and the like. Merely by way of example, the network 810 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 802, 804, 806 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 806) may be dedicated to running applications, such as a business application, a Web server, application server, etc. Such servers may be used to process requests from user computers 812, 814, 816, 818. The applications can also include any number of applications for controlling access to resources of the servers 802, 804, 806.

The Web server can be running an operating system including any of those discussed above, as well as any commercially-available server operating systems. The Web server can also run any of a variety of server applications and/or mid-tier applications, including E-Mail servers, HTTP servers, FTP servers, CGI servers, database servers, Java servers, business applications, and the like. The server(s) also may be one or more computers which can be capable of executing programs or scripts in response to the user computers 812, 814, 816, 818. As one example, a server may execute one or more Web applications. The Web application may be implemented as one or more scripts or programs written in any programming language, such as Java®, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 812, 814, 816, 818.

The system 800 may also include one or more databases 820. The database(s) 820 may reside in a variety of locations. By way of example, a database 820 may reside on a storage medium local to (and/or resident in) one or more of the computers 802, 804, 806, 812, 814, 816, 818. Alternatively, it may be remote from any or all of the computers 802, 804, 806, 812, 814, 816, 818, and/or in communication (e.g., via the network 810) with one or more of these. In a particular set of embodiments, the database 820 may reside in a storage-area network (“SAN”) familiar to those skilled in the art. Similarly, any necessary files for performing the functions attributed to the computers 802, 804, 806, 812, 814, 816, 818 may be stored locally on the respective computer and/or remotely, as appropriate. In one set of embodiments, the database 820 may be a relational database, such as Oracle 10g, that is adapted to store, update, and retrieve data in response to SQL-formatted commands.

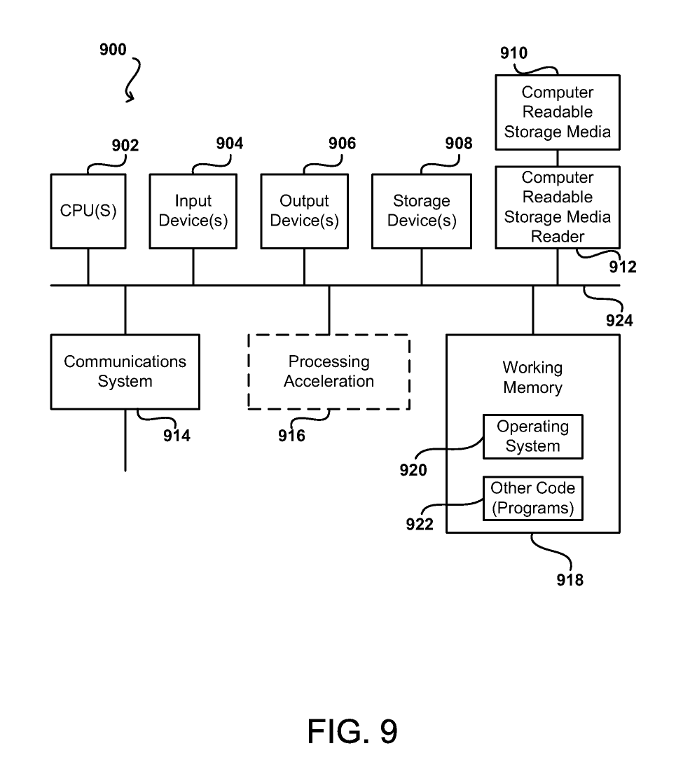

FIG. 9 illustrates an exemplary computer system 900, in which various embodiments may be implemented. The system 900 may be used to implement any of the computer systems described above. The computer system 900 is shown comprising hardware elements that may be electrically coupled via a bus 924. The hardware elements may include one or more central processing units (CPUs) 902, one or more input devices 904 (e.g., a mouse, a keyboard, etc.), and one or more output devices 906 (e.g., a display device, a printer, etc.). The computer system 900 may also include one or more storage devices 908. By way of example, the storage device(s) 908 can include devices such as disk drives, optical storage devices, solid-state storage device such as a random access memory (“RAM”) and/or a read-only memory (“ROM”), which can be programmable, flash-updateable and/or the like.

The computer system 900 may additionally include a computer-readable storage media reader 912, a communications system 914 (e.g., a modem, a network card (wireless or wired), an infra-red communication device, etc.), and working memory 918, which may include RAM and ROM devices as described above. In some embodiments, the computer system 900 may also include a processing acceleration unit 916, which can include a digital signal processor DSP, a special-purpose processor, and/or the like.

The computer-readable storage media reader 912 can further be connected to a computer-readable storage medium 910, together (and, optionally, in combination with storage device(s) 908) comprehensively representing remote, local, fixed, and/or removable storage devices plus storage media for temporarily and/or more permanently containing, storing, transmitting, and retrieving computer-readable information. The communications system 914 may permit data to be exchanged with the network and/or any other computer described above with respect to the system 900.

The computer system 900 may also comprise software elements, shown as being currently located within a working memory 918, including an operating system 920 and/or other code 922, such as an application program (which may be a client application, Web browser, mid-tier application, RDBMS, etc.). It should be appreciated that alternate embodiments of a computer system 900 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A method of replying to an e-mail comprising:
receiving an e-mail at a user's secondary e-mail account on a second e-mail server, the e-mail sent from a sender's e-mail account on a third e-mail server;
appending a link to the e-mail, the link including computer instructions for sending a reply e-mail to the sender;
forwarding the e-mail to a user's primary e-mail account at a first e-mail server; and
sending the reply e-mail from the second e-mail server to the sender's e-mail account on the third e-mail server, wherein the reply e-mail includes a from address identifying the secondary e-mail account.

2. The method of claim 1 wherein operation of the method is independent of the first and third e-mail servers.

3. The method of claim 2 wherein the e-mail sent from the sender is embedded into an HTML form prior to appending the link to the e-mail and the link is an HTML mailto command, the mailto command specifying a destination address associated with the second e-mail server.

4. The method of claim 3 wherein the destination address is the user's secondary e-mail account plus an additional identifier that is recognized by the second e-mail server.

5. The method of claim 4 further comprising:
receiving, at the second e-mail server, an e-mail initiated by clicking on the mailto: link;
parsing the destination address to recognize the additional identifier;
extracting the additional identifier to retrieve the user's secondary e-mail account;
extracting, from the e-mail generated by clicking on the mailto: link, the sender's e-mail account;
creating the reply e-mail addressed to the sender's e-mail account; and
sending the reply e-mail to the sender's e-mail account from the user's secondary e-mail account at the second mail server.

6. The method of claim 5 further including placing a copy of the reply e-mail in a sent items folder in the user's secondary e-mail account.

7. The method of claim 2 wherein activating the appended link causes the second e-mail server to generate a web page that contains the reply e-mail addressed to the sender's e-mail account and sends the web page to a user's computer.

8. The method of claim 7 wherein the web page includes a send link, wherein activating the send link causes the reply e-mail to be sent from the second e-mail server to the sender's email account.

9. A computer readable storage medium storing a plurality of instructions for controlling a processor, the instructions causing the processor to perform the method of claim 1.

10. A system for replying to an e-mail, the system comprising:
a processor; and
a memory coupled to the processor, the memory comprising code for receiving an e-mail at a user's secondary e-mail account at a second e-mail server, the e-mail sent from a sender's e-mail account on a third e-mail server, code for appending a link to the e-mail, the link including computer instructions for sending a reply e-mail to the sender, code for forwarding the e-mail to a user's primary e-mail account at a first e-mail server, and code for sending the reply e-mail from the second e-mail server to the sender's e-mail account on the third e-mail server, wherein the reply e-mail includes a from address identifying the secondary e-mail account.

11. The system of claim 10 wherein the memory further includes code for embedding the e-mail sent from the sender into an HTML form prior to appending the link to the e-mail and the link is an HTML mailto command, the mailto command specifying a destination address associated with the second e-mail server, the destination address comprising the user's secondary e-mail account plus an additional identifier that is recognized by the second e-mail server.

12. The system of claim 11 wherein the memory further includes code for receiving, at the second e-mail server, an e-mail initiated by clicking on the mailto: link, code for parsing the destination address to recognize the additional identifier, code for extracting the additional identifier to retrieve the user's secondary e-mail account, code for extracting, from the e-mail generated by clicking on the mailto: link, the sender's e-mail account, code for creating the reply e-mail addressed to the sender's e-mail account, and code for sending the reply e-mail to the sender's e-mail account from the user's secondary e-mail account at the second mail server.

13. The system of claim 10 wherein the memory further includes code for generating, on the second e-mail server, in response activating the appended link, a web page that contains the reply e-mail addressed to the sender's e-mail account and sends the web page to a user's computer, and code for including a send link on the web page, wherein activating the send link causes the reply e-mail to be sent from the second e-mail server to the sender's email account.

14. A method of replying to an e-mail comprising:
receiving an e-mail at a user's secondary e-mail account on a second e-mail server, the e-mail sent from a sender's e-mail account on a third e-mail server;
altering a from address field of the e-mail to include an identifier recognizable by the second e-mail server, the identifier indicating further processing is required for e-mails sent to the altered address;
forwarding the e-mail with the altered from address field to a user's primary e-mail account at a first e-mail server;
receiving, at the second e-mail server, a reply e-mail addressed to the altered from address field;
processing the reply e-mail to retrieve the user's secondary e-mail account and the sender's e-mail account; and
sending the reply e-mail from the user's secondary e-mail account to the sender's e-mail account.

15. The method of claim 14 wherein operation of the method is independent of the first and third e-mail servers.

16. The method of claim 15 wherein the step of altering the from address field includes appending the user's secondary e-mail account to the from address field.

17. A computer readable storage medium storing a plurality of instructions for controlling a processor, the instructions causing the processor to perform the method of claim 14.

18. A system for replying to an e-mail, the system comprising:
a processor; and
a memory coupled to the processor, the memory comprising code for receiving an e-mail at a user's secondary e-mail account on a second e-mail server, the e-mail sent from a sender's e-mail account on a third e-mail server, code for altering a from address field of the e-mail to include an identifier recognizable by the second e-mail server, the identifier indicating further processing is required for e-mails sent to the altered address, code for forwarding the e-mail with the altered from address field to a user's primary e-mail account at a first e-mail server, code for receiving, at the second e-mail server, a reply e-mail addressed to the altered from address field, code for processing the reply e-mail to retrieve the user's secondary e-mail account and the sender's e-mail account, and code for sending the reply e-mail from the user's secondary e-mail account to the sender's e-mail account.
